(19) United States
(12) Patent Application Publication
(10) Pub. No.: US 2022/0176576 A1
(43) Pub. Date: Jun. 9, 2022

(54) RAZOR TOOL AND METHOD

(71) Applicant: JASON D. LOPEZ DBA THE DEN BARBERING, Los Angeles, CA (US)

(72) Inventor: Jason D. Lopez, Los Angeles, CA (US)

(21) Appl. No.: 17/116,116

(22) Filed: Dec. 9, 2020

(51) Int. Cl. B26B 21/52

(52) U.S. Cl. CPC B26B 21/521

(57) ABSTRACT

A razor tool having a plate with a first end, a second end, an inside surface, and at least one protrusion extending from the inside surface of the plate. A handle is removably and rotatably coupled to the second end of the plate. A razor housing is adapted to removably receive at least one razor blade, and the razor housing includes at least one hole aligned with the at least one protrusion of the plate and removably secured to the plate via the at least one protrusion.

### FIELD OF DISCLOSURE

The present disclosure relates generally to razors and, more specifically, to a razor tool.

### BACKGROUND

Razor blades are frequently used in barber shops and hair salons, such as in providing shaving services for male clients. Many standard razor blades are a one-size fits all device. However, the same size standard razor blade is used on clients having many different face sizes and shapes, leading to deficiencies in performance of the standard size blade and shaving services, for example. In addition, during use razor blades often stop working properly, which requires another razor blade to be retrieved and used, interrupting service to the client for often longer periods of time than desired.

### SUMMARY

In accordance with the principles of the present disclosure, a razor tool comprises a plate having a first end, a second end, an inside surface, and at least one protrusion extending from the inside surface of the plate. A handle is removably and rotatably coupled to the second end of the plate via an attachment mechanism. In addition, the razor tool also includes a razor housing adapted to removably receive at least one razor blade. The razor housing includes at least one hole aligned with the at least one protrusion of the plate and is removably secured to the plate via the at least one protrusion. The razor housing also includes at least one magnetic component to removeably secure the at least one razor blade to the razor housing.

In accordance with another example, a razor tool comprises a plate having a first end, a second end, and at least one magnetic component. In addition, a handle is removably and rotatably coupled to the second end of the plate. In addition, a razor housing is coupled to the plate near the first end of the plate and is adapted to removably receive at least one razor blade. The razor housing includes at least one magnetic component to removeably secure the at least one razor blade to the razor housing. So configured, the at least one magnetic component of the razor housing aligns with the at least one magnetic component of the plate.

In accordance with another example, a method of assembling a razor tool comprises providing a plate having a first end, a second end, an inside surface, and at least one protrusion extending from the inside surface of the plate. The method also includes removably and rotatably coupling a handle to the second end of the plate via an attachment mechanism. In addition, the method includes securing a razor housing adapted to removably receive at least one razor blade to the plate near the first end of the plate via at least one protrusion of the plate that aligns with at least one hole of the razor housing.

### BRIEF DESCRIPTION OF THE DRAWINGS

These and other features and advantages of the various exemplary embodiments disclosed herein will be better understood with respect to the following description and drawings, in which:

FIG. 1 is perspective view of a razor tool of the present disclosure.

FIG. 2 is a portion of the razor tool of FIG. 1.

FIG. 3 a perspective view of a razor housing of the razor tool of FIG. 1.

FIG. 4A is an exploded view of a portion of the razor tool of FIG. 1 without a razor blade disposed therein.

FIG. 4B is another exploded view of a portion of the razor tool of FIG. 1 with a razor blade disposed therein.

FIG. 5 is a side view of an attachment mechanism of the razor tool of FIG. 1.

FIG. 6 is a perspective view of the attachment mechanism of FIG. 5.

FIG. 7 is a handle of the razor tool of FIG. 1.

FIG. 8 is a side view of another razor housing that may be used with the razor tool of FIG. 1.

FIG. 9A is a bottom perspective view of the razor housing of FIG. 8.

FIG. 9B is a top perspective view of the razor housing of FIG. 9A.

FIG. 10 is a side view of another plate that may be used with the razor tool of FIG. 1.

FIG. 11 is a perspective view of the plate of FIG. 10.

### DETAILED DESCRIPTION

The detailed description set forth below in connection with the appended drawings is intended as a description of certain exemplary embodiments of various system components constructed in accordance with the principles herein. These examples are not intended to represent the only embodiments or forms that may be developed or utilized according to these principles. It is further understood that the use of relational terms such as first and second, and the like are used solely to distinguish one entity from another without necessarily requiring or implying any actual such relationship or order between such entities.

Generally, a razor tool having a plate, a handle removably and rotatably coupled to the plate via an attachment mechanism, and a razor housing including at least one razor and attached to the plate is disclosed. The razor housing and razor disposed therein fit within a sleeve of the handle when in an unused position and may be rotatably moved from the unused position to a use position in which the plate is at least perpendicular to the handle and the razor is exposed from the razor housing, for example. The razor blade is easily removable and replaceable within the razor housing due to magnetic components disposed in both the plate and the razor housing that together interact to maintain the position of the razor blade within the housing during use, but are easily movable to remove the razor blade. Specifically, upon applying a force slightly greater than the force of the magnetic attraction of the respective magnetic components to the razor housing, the razor housing may be moved to remove and/or replace the razor blade when needed.

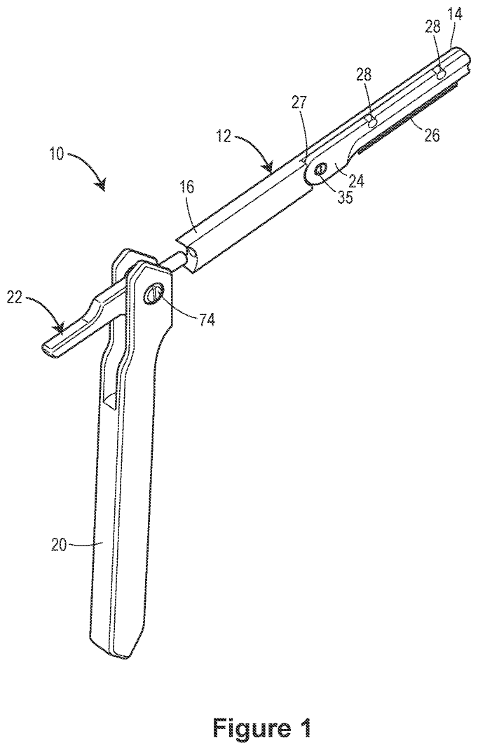

Referring now to FIG. 1, a razor tool 10 of the present disclosure is depicted. The razor tool 10 includes a plate 12 having a first end 14 and a second end 16. A handle 20 is removably and rotatably coupled to the second end 16 of the plate 12 via an attachment mechanism 22. A razor housing 24 is adapted to removably receive at least one razor blade 26 and is removably secured to the plate 12 near the first end 14 of the plate 12. As further depicted in FIG. 1, the plate 12 also includes an inside surface 27 and at least one protrusion 28 extending from the inside surface 27. Specifically, and in one example, the at least one protrusion 28 includes a plurality of protrusions 28, such as two protrusions 28, that extend from the inside surface 27 near the first end 14 of the plate, as depicted in FIG. 1. As will be appreciated, more than two protrusions 28 may alternatively and/or additionally be used and still fall within the scope of the present disclosure. In addition, the plate 12 includes a post 29 disposed in a central location of the plate 12. In this example, the post 29 fits within a hole of the razor housing 24 when the razor housing 24 is secured to the plate 12, as explained more below.

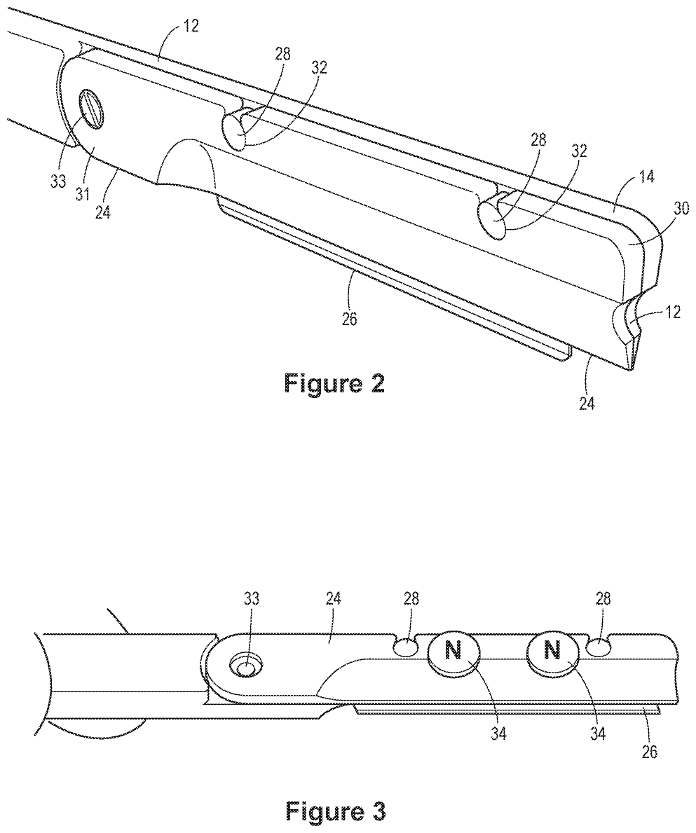

Referring now to FIGS. 2 and 3, the razor housing 24 includes a first end 30 and a second end 31 and at least one hole 32 aligned with the at least one protrusion 28 of the plate 12. The at least one protrusion 28 fits into the at least one hole 32 of the razor housing 24 to help secure the razor housing 24 to the plate 12. In this example, the at least one hole 32 of the razor housing 24 includes a plurality of holes 32, such as two holes 32, that align with and receive the two protrusions 28 of the plate 12. As will again be appreciated, more than two holes 32 may be additionally and/or alternatively be used and still fall within the scope of the present disclosure.

In addition, the razor housing 24 includes another hole 33 disposed near the second end 31 of the razor housing 24, as depicted in both FIGS. 2 and 3. The hole 33 aligns with the post 29 in the plate 12 and a fastener 35 (FIG. 1), such as a pivot pin, is disposed within the hole 33 to help secure the razor housing 24 to the plate 12. As will be understood, the fastener 35 may include any type of fastener in addition to or different from the pivot pin and still fall within the scope of the present disclosure.

As depicted in FIG. 3, the razor housing 24 also includes at least one magnetic component 34 to help removably secure the at least one razor blade 26 to the razor housing 24. In this example, the at least one magnetic component 34 includes two magnetic components 34, both of which are disposed between the two holes 32 of the razor housing 24. As explained more below, and in one example, the at least one magnetic component 34 is aligned and interacts with at least one other magnetic component disposed within the plate 12 to secure the razor blade 26 to the razor housing 24. More specifically, the razor blade 26 is disposed between the plate 12 and the razor housing 24. The magnetic force between the magnetic components 34 of the razor housing 24 and the magnetic components of the plate 12 help maintain a position of the razor blade 26 between the plate 12 and the razor housing 24.

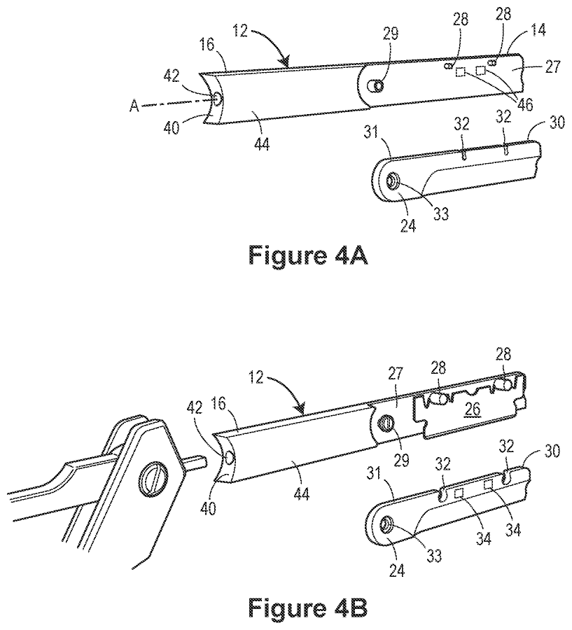

Referring now to FIGS. 4A and 4B, the second end 16 of the plate 12 may include a concave surface 40 and a slot 42 disposed along a longitudinal axis A (FIG. 4A) of the plate 12. In addition, the plate 12 also includes a shank 44 disposed near the second end 16 of the plate 12. As explained more below, the plate 12 includes a surface having a shape that matches the shape of a portion of the attachment mechanism 22 and at least one magnetic component 46, as depicted in FIG. 4A. In this example, the plate 12 includes two magnetic components 46 disposed within a body of the plate 12, near the first end 14 of the plate 12, and between the protrusions 28 extending from the inner surface 27. The magnetic components 46 of the housing 12 align with the magnetic components 34 (see FIGS. 3 and 4B) of the razor housing 24 to help secure the razor housing 24 to the plate 12.

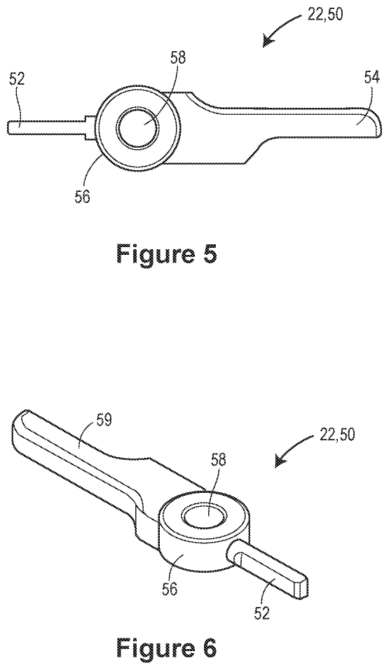

Referring now to FIGS. 5 and 6, an exemplary attachment mechanism 22 of FIG. 1 is depicted. In this example, the attachment mechanism 22 is a finger rest 50 having a rod 52 and a gripping portion 54. When the razor tool 10 is completely assembled, the rod 52 is disposed within the slot 42 of the second end 16 of the plate 12 to rotatably secure the plate 12 to the handle 20. In one example, the rod 52 includes a magnetic material, which enables to rod 52 to securely fit within the slot 42, for example. In addition, the finger rest 50 includes a shoulder 56 disposed between the rod 52 and the gripping portion 54, such that each of the rod 52 and the gripping portion 54 extend outwardly from the shoulder 56. In this example, the rod 52 extends outwardly in a first direction and the gripping portion 54 extends outwardly in a second direction opposite to the first direction, but along the same axis as the first direction. Further, the shoulder 56 includes an aperture 58 adapted to receive a fastener, such as a pin or a pivot pin, to help secure the handle 20 to the finger rest 50 and, ultimately, to the plate 12, as explained more below.

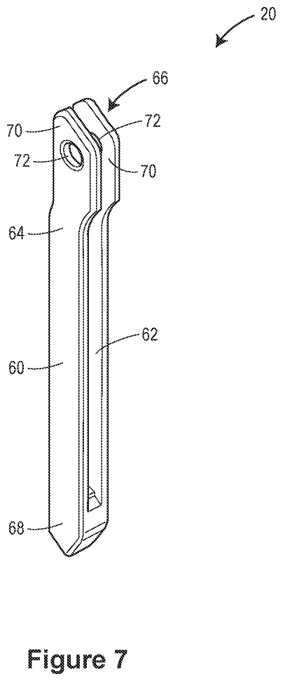

Referring now to FIG. 7, the handle 20 of the razor tool 10 is depicted. The handle 20 includes a body 60 and an inner sleeve 62 adapted to receive a portion of the plate 12 and the razor housing 24 when the razor blade 26 is not in use. In this way, the razor blade 26 and razor housing 24 are disposed within the inner sleeve 62, preventing a user from inadvertent cuts, nicks and/or harm from the razor blade 26, for example. In addition, the body 60 also includes a first end 64 having a pair of arms 66 extending from the first end 64 and a second end 68 disposed opposite the first end 64, as depicted in FIG. 7. Each arm 70 of the pair of arms 66 includes an aperture 72 for receiving a fastener 74 (FIG. 1). The fastener 74 is also adapted to attach the attachment mechanism 22, such as the finger rest 50, to the handle 20, as depicted in FIG. 1.

Specifically, and referring back to FIGS. 5 and 6, the aperture 58 of the shoulder 56 of the finger rest 50 is aligned with the apertures 72 of each arm 70 of the pair of arms 66 of the handle 20 when the shoulder 56 of the finger rest 50 is disposed between the pair of arms 66. Each aperture 72 of each arm 70 and the aperture 58 of the shoulder 56 receive at least one pivot pin 74 to rotatably secure the finger rest 50 to the handle 20. When the rod 52 of the finger rest 50 is disposed in the slot 42 of the plate 12, the plate 12 is also rotatably secured to the handle 20. In addition, a surface, such as the concave surface 40 (FIGS. 4A and 41B) of the plate 12, has a rounded portion that matches a shape of the shoulder 56 of the finger rest 50. As a result, when the rod 52 of the finger rest 50 is disposed within the slot 42 of the plate 12, the concave surface 40 contacts the rounded shape of the shoulder 56 of the finger rest 50. As will be appreciated, both the surface 40 of the plate 12 and the shoulder 56 may include a different shape, such that each of the shapes are matching or not matching, and still fall within the scope of the present disclosure.

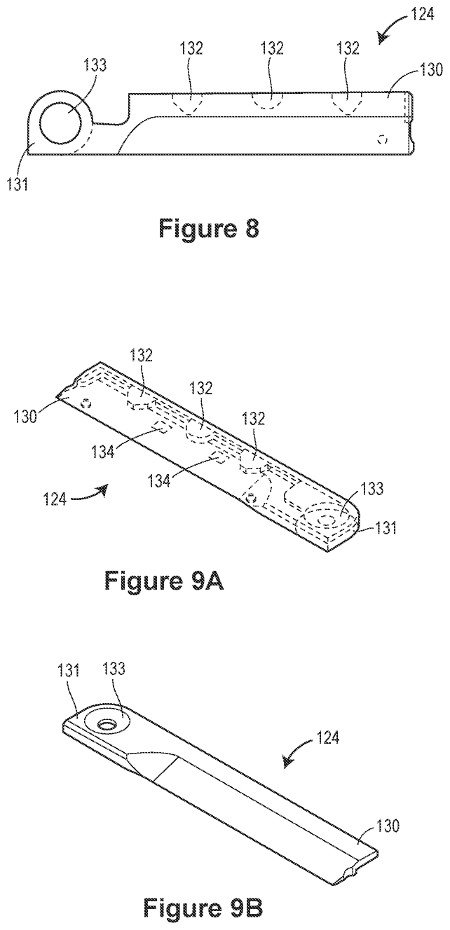

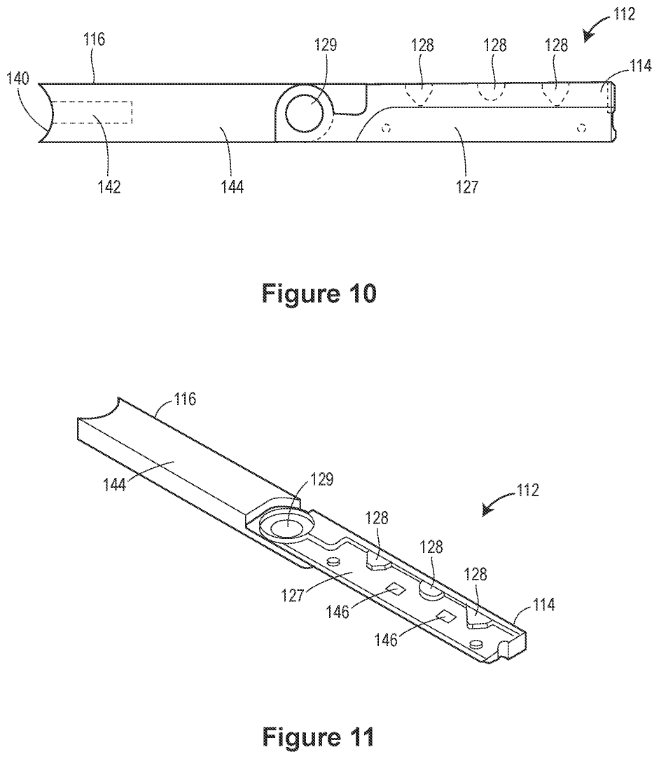

Referring now to FIGS. 8-11, an alternative razor housing 124 and plate 112 are depicted. Specifically, FIGS. 8, 9A and 9B depict the razor housing 124, and FIGS. 10 and 11 depict the plate 112. The razor housing 124 includes almost of all of the same features as the previously described razor housing 24 of the razor tool 10, but includes more apertures disposed in the razor housing 124, for example. In a similar manner, the plate 112 of FIGS. 10 and 11 also includes almost all of the same features of the plate 12 described above, but includes more protrusions that align with the apertures of the razor housing 124 to help secure the razor housing 24 to the plate, for example, and as explained more below. The plate 112 and the razor housing 124 may be used with the razor tool 10 described above, as will be in understood in view of the foregoing and the following features. As such, parts of the razor housing 124 and the plate 112 similar to or the same as the previously described razor housing 24 and plate 12, respectively, are numbered 100 more than the razor housing 24 and plate 12 of FIGS. 1-4B, for example.

More specifically, and as depicted in FIGS. 8-9B, the razor housing 124 includes a first end 130 and a second end 131 and at least one hole 132 aligned with at least one protrusion 128 of the plate 112 (FIGS. 10 and 11). The at least one protrusion 128 (FIGS. 10 and 11) fits into the at least one hole 132 of the razor housing 124 to help secure the razor housing 124 to the plate 112. In this example, the at least one hole 132 of the razor housing 124 includes a plurality of holes 132, such as three holes 132, that align with and receive three corresponding protrusions 128 of the plate 112. As will again be appreciated, more than three holes 132 may be additionally and/or alternatively be used and still fall within the scope of the present disclosure. In addition, the plate 112 includes an aperture 129 disposed in a central location of the plate 112 that aligns with another hole of the razor housing 124, as explained more below.

In addition, the razor housing 124 includes another hole 133 disposed near the second end 131 of the razor housing 124. The hole 133 aligns with another hole in the plate 112 and a fastener 35 (FIG. 1), such as a pivot pin, is disposed within the hole 133 and another hole of the plate 112 to help secure the razor housing 124 to the plate 112. As will be understood, the fastener 35 may include any type of fastener in addition to or different from the pivot pin and still fall within the scope of the present disclosure.

As depicted in FIG. 9A, the razor housing 124 also includes at least one magnetic component 134 to help removably secure the at least one razor blade 126 to the razor housing 124. In this example, the at least one magnetic component 134 includes two magnetic components 134, both of which are disposed between the two of the three holes 132 of the razor housing 124. Like the magnetic components 34 of the razor housing 24, the at least one magnetic component 134 is aligned and interacts with at least one other magnetic component disposed within the plate 112 to secure the razor blade 126 to the razor housing 124. More specifically, a razor blade (not depicted) is disposed between the plate 112 and the razor housing 124. The magnetic force between the magnetic components 134 of the razor housing 124 and the magnetic components of the plate 112 help maintain a position of the razor blade 126 between the plate 112 and the razor housing 124.

Referring now to FIGS. 10 and 11, the plate 112 includes a first end 114 and a second end 16. The handle 20 may be removably and rotatably coupled to the second end 116 of the plate 112 via the attachment mechanism 22 described above. The razor housing 124 is also adapted to removably receive at least one razor blade 26 and may be removably secured to the plate 112 near the first end 114 of the plate 112. As further depicted in FIGS. 10 and 11, the plate 112 also includes an inside surface 127 and the at least one protrusion 128 extending from the inside surface 127. Specifically, and in one example, the at least one protrusion 128 includes a plurality of protrusions 128, such as three protrusions 128, that extend from the inside surface 127 near the first end 114 of the plate. As will be appreciated, more than three protrusions 128 may alternatively and/or additionally be used and still fall within the scope of the present disclosure.

In addition, the second end 116 of the plate 112 may include a concave surface 140 and a slot 142 disposed along a longitudinal axis B of the plate 112. In addition, the plate 112 also includes a shank 144 disposed near the second end 116 of the plate 112. The plate 112 also includes a surface, such as the concave surface 140, having a shape that matches the shape of a portion of the attachment mechanism 22. In addition, the plate 112 includes at least one magnetic component 146, as depicted in FIG. 11. In this example, the plate 112 includes two magnetic components 146 disposed within a body of the plate 112, near the first end 114 of the plate 112, and between the protrusions 128 extending from the inner surface 127. The magnetic components 146 of the housing 112 align with the magnetic components 134 (FIG. 9A) of the razor housing 124 to help secure the razor housing 124 to the plate 112.

In view of the foregoing, a method of assembling the razor tool 10 of the present disclosure will be understood. For example, one method of assembling the razor tool 10 includes providing the plate 12, 112 having a first end 14, 114, a second end 16, 116, an inside surface 27, 127, and at least one protrusion 28, 128 extending from the inside surface 27, 127 of the plate 12, 112. The method of assembling further includes removably and rotatably coupling the handle 20 to the second end 16, 116 of the plate 12, 112 via an attachment mechanism 22, 122. In addition, the method of assembling also includes securing the razor housing 24, 124 adapted to removably receive the at least one razor blade 26 to the plate 12, 112 near the first end 14, 114 of the plate 12, 112 via at least one protrusion 28, 128 of the plate 12, 112 that aligns with at least one hole 32, 132 of the razor housing 24, 124

In some examples, the method may also include aligning at least one magnetic component 34, 134 of the razor housing 24, 124 with at least one magnetic component 46, 146 of the plate 12, 112 to secure the razor blade 26 to the razor housing 24, 124. In another example, removably and rotatably coupling the handle 20 to the second end 16, 116 of the plate 12, 112 via the attachment mechanism 22 further comprises removably and rotatably coupling the handle 20 to the second end 16, 116 of the plate 12, 112 via the finger rest 50 having the rod 52 and the gripping portion 54, disposing the rod 52 within a portion of the second end 16, 116 of the plate 12, 112.

In view of the foregoing, it will be understood that the razor tool 10 of the present disclosure includes several advantages. For example, the razor tool 10 is able to be more easily maneuvered and used on a variety of different face sizes and shapes due at least to the unique configuration of the handle 20 that is removably and rotatably coupled to the plate 12 via the finger rest 50, for example. In addition, when a new razor blade is needed, the razor housing 24, 124 is able to be easily removed from the plate 12, 112 when a force just slightly greater than the force of the magnetic components 34, 134 of the razor housing 24, 124 and the magnetic components 46, 146 of the plate 12, 112 is applied to the razor housing 24, 124, for example. This allows the old razor blade 26 to be removed from the razor tool 10 and then easily and quickly replaced with another new razor blade 26, reducing the time involved in razor blade replacement and increasing the efficiency of service to a client.

Further, the razor tool 10 allows a practitioner to mount or dismount and/or couple or uncouple the razor blade 26 to the razor housing 24, 124 via the magnetic components 46, 146, for example. As a result, the razor blade 26 does not need to be handled with his or her own hand. The razor tool 10 may be referred to as a shavette straight razor tool in some examples, and used to perform any shaving and grooming needs that involve the use of a shavette straight razor. The razor tool 10 also allows many attachments to be used with the same handle, and the razor housing 24, 124 is reduced and condensed in surface area size to achieve and maintain a desired shaving angle of 30 degrees. This reduced and condensed area of the razor housing 24, 124 accommodates the standard razor blade dimensions in the current market. Moreover, the razor tool 10 is designed with an interchangeable razor blade housing 24, 124 (as described above) that utilizes one hand and multiple attachments, allowing a practitioner the freedom to choose a desired blade size. Specifically, the rod 52 that fits into the slot of the razor blade housing 24,124 helps enable a practitioner to easily remove an old razor housing 24, 124 out of alignment and connection with the rod 52 and replace it with any one of multiple ready to use other razor housings, with a razor blade secured therein, by aligning the rod 52 with the slot of the additional, new razor housing.

Still further, the handle of the razor tool 10 includes a unique angle where it is connected to the shank, enabling enhanced comfort and control for the practitioner during use. For example, the angle is strategically placed where the thumb, index finger and middle finger meet to hold the device properly. Moreover, the razor tool 10 may also include an inner plastic lining that serves as a measure of hygiene and protection for the razor blade housing 24,124.

In addition, the razor system 10 and its components described above may include, but not be limited to any one or more of plastic, stainless steel, wood, aluminum, silicone and magnetic materials. Specifically, the handle may be made of plastics, metals, wood and/or organic materials of all types. The razor housing may be made of any type of metal. The plate may be made of plastics and/or any type of metal. More generally, the plastic materials may include one or more of recycled plastic and/or plant plastic. The metals may include recycled metals, such as stainless steel, carbon steel and/or brushed aluminum. The wood material may include recycled wood.

It will be further understood that the magnetic components of the razor tool 10 of the present disclosure allows the practitioner to mount/unmount or couple/uncouple the razor blade 26 to the razor housing 24, 124, such as by tapping the razor housing 24, 124 on the razor blade 26, allowing the magnetic components to engage and mount/couple the razor in place. This configuration results in a reduced need to engage the razor with the practitioner's bare hand. In addition, the razor housing 24, 124 provides a slimmer and more space efficient razor housing, where the razor blade 26 is held and secured into place before use. Specifically, current razor housing components are typically 15.56 mm in width. In contrast, the razor housing 24, 124 of the present invention is much smaller, such as 5.56 mm in width, resulting in a reduction of surface size of 10 mm in this example. This reduction in size allows the practitioner to maintain the proper shaving angle of 30 degrees from contact with the skin in tight and narrow spaces (e.g., under the nose, around the lips and chin areas), while still accommodating the current various razor blade sizes.

Still further, the razor housing 24, 124 of the razor tool 10 of the present invention is interchangeable, utilizing the magnetic components that allows for pre-loaded razor housings 24, 124 to be on standby when needed. In particular, often times the current razor in use loses its sharpness during service. This interchangeable feature accommodates multiple razor blade sizes currently in the market, as well as uniquely designed razors yet to be produced.

Although the foregoing text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Variations of the specific device configurations shown and described herein are within the scope of the principles of the present disclosure, and are included in all claims deriving therefrom.

What is claimed:

1. A razor tool comprising:
a plate having a first end, a second end, an inside surface, and at least one protrusion extending from the inside surface of the plate;
a handle removably and rotatably coupled to the second end of the plate via an attachment mechanism; and
a razor housing adapted to removably receive at least one razor blade, the razor housing having at least one hole aligned with the at least one protrusion of the plate and removably secured to the plate via the at least one protrusion, the razor housing including at least one magnetic component to removeably secure the at least one razor blade to the razor housing.

2. The razor tool of claim 1, where the second end of the plate includes one or more of a concave surface and a slot disposed along a longitudinal axis of the plate.

3. The razor tool of claim 1, where the handle includes a body having an inner sleeve adapted to receive a portion of the plate and the razor housing.

4. The razor tool of claim 2, wherein the attachment mechanism is a finger rest having a rod and a gripping portion, the rod disposed within the slot of the second end of the plate to rotatably secure the plate to the handle.

5. The razor tool of claim 4, where the body of the handle includes a first end having a pair of arms extending therefrom, each arm having an aperture for receiving a fastener adapted to attach the attachment mechanism to the handle.

6. The razor tool of claim 5, where the finger rest includes a shoulder disposed between the pair of arms, the shoulder having an aperture that aligns with the aperture of each arm of the pair of arms, each aperture of each arm of the pair of arms and the aperture of the shoulder adapted to receive at least one pivot pin to rotatably secure the plate to the handle.

7. The razor tool of claim 1, where the plate includes a shank disposed near the second end of the plate, a surface of the plate matching a rounded surface of a shoulder of the finger rest.

8. The razor tool of claim 1, wherein the plate includes at least one magnetic component that aligns with the at least one magnetic component disposed in the razor housing.

9. The razor tool of claim 1, wherein the plate includes a plurality of protrusions and the razor housing includes a plurality of holes that align with the plurality of protrusions to secure the razor housing to the plate.

10. The razor tool of claim 1, wherein the at least one magnetic component of the razor housing includes a pair of magnetic components disposed within the razor housing, and the plate includes a pair of magnetic components disposed in the plate near the first end of the plate, such that the pair of magnetic components of the razor housing align with the pair of magnetic components of the plate to secure the razor to the razor housing.

11. A razor tool comprising:
a plate having a first end, a second end, and at least one magnetic component;
a handle removably and rotatably coupled to the second end of the plate; and
a razor housing coupled to the plate near the first end of the plate and adapted to removably receive at least one razor blade, the razor housing including at least one magnetic component to removeably secure the at least one razor blade to the razor housing, where the at least one magnetic component of the razor housing aligns with the at least one magnetic component of the plate.

12. The razor tool of claim 11, further comprising an attachment mechanism including a finger rest having a rod and a gripping portion, the rod disposed within a portion of the second end of the plate to rotatably secure the plate to the handle.

13. The razor tool of claim 12, where the body of the handle includes a first end having a pair of arms extending therefrom, each arm having an aperture for receiving a fastener adapted to attach the attachment mechanism to the handle.

14. The razor tool of claim 13, where the finger rest includes a shoulder disposed between the pair of arms, the shoulder having an aperture that aligns with the aperture of each arm of the pair of arms, each aperture of each arm of the pair of arms and the aperture of the shoulder adapted to receive at least one pivot pin to rotatably secure the plate to the handle.

15. The razor tool of claim 14, where the plate includes a shank disposed near the second end of the plate, a surface of the plate matching a rounded surface of a shoulder of the finger rest.

16. The razor tool of claim 1, the plate further comprising at least one protrusion, and the razor housing having at least one hole aligned with the at least one protrusion of the plate and removably secured to the plate via the at least one protrusion.

17. The razor tool of claim 1, wherein the plate includes a plurality of protrusions and the razor housing includes a plurality of holes that align with the plurality of protrusions to secure the razor housing to the plate.

18. A method of assembling a razor tool, the method comprising:
providing a plate having a first end, a second end, an inside surface, and at least one protrusion extending from the inside surface of the plate;
removably and rotatably coupling a handle to the second end of the plate via an attachment mechanism; and
securing a razor housing adapted to removably receive at least one razor blade to the plate near the first end of the plate via at least one protrusion of the plate that aligns with at least one hole of the razor housing.

19. The method of claim 18, further comprising aligning at least one magnetic component of the razor housing with at least one magnetic component of the plate to secure the razor blade to the razor housing.

20. The method of claim 18, wherein removably and rotatably coupling a handle to the second end of the plate via an attachment mechanism further comprises removably and rotatably coupling a handle to the second end of the plate via a finger rest having a rod and a gripping portion, disposing the rod within a portion of the second end of the plate.
